(19) United States
(12) Patent Application Publication
(10) Pub. No.: US 2013/0009563 A1
(43) Pub. Date: Jan. 10, 2013

(54) RESONANCE CIRCUITRY FOR A FIELD EMISSION LIGHTING ARRANGEMENT

(75) Inventor: Qiu-Hong Hu, Goteborg (SE)

(73) Assignee: Lightlab Sweden Ab, Stockholm (SE)

(21) Appl. No.: 13/517,137

(22) PCT Filed: Nov. 29, 2010
(86) PCT No.: PCT/EP2010/068419

§ 371 Date: Sep. 26, 2012

(30) Foreign Application Priority Data
Dec. 21, 2009 (EP) 09180155.5

(51) Int. Cl. H05B 41/24

(52) U.S. Cl. 315/248

(57) ABSTRACT

A field emission lighting arrangement of at least one embodiment includes a field emission light source including an anode and a cathode and having an inherent predetermined capacitance; an inductor having a predetermined inductance and connected to at least one of the anode and the cathode of the field emission light source; and a power supply connected to the field emission light source and the inductor and configured to provide a drive signal for powering the field emission light source, the drive signal including a first frequency component having a first frequency selected to be within a frequency range, based on the predetermined capacitance and the predetermined inductance, corresponding to the half power width at resonance of the field emission lighting arrangement. At least one embodiment results in lower power consumption as well as an increase in light output of the field emission lighting arrangement.

### TECHNICAL FIELD

The present invention relates to a field emission lighting arrangement. More specifically, the invention relates to means for essentially driving the field emission arrangement at resonance.

### BACKGROUND OF THE INVENTION

There is currently a trend in replacing the traditional light bulb with more energy efficient alternatives. Florescent light sources also in forms resembling the traditional light bulb have been shown and are often referred to as compact fluorescent lamps (CFLs). As is well known, all florescent light sources contain a small amount of mercury, posing problems due to the health effects of mercury exposure. Additionally, due to heavy regulation of the disposal of mercury, the recycling of florescent light sources becomes complex and expensive.

Accordingly, there is a desire to provide an alternative to florescent light sources. An example of such an alternative is provided in WO 2005074006, disclosing a field emission light source containing no mercury or any other health hazardous materials. The field emission light source includes and anode and a cathode, the anode comprising an electrically conductive layer and a luminescent layer that is luminescent when excited by electron bombardment caused by a potential difference between the electrically conductive layer and the cathode. For achieving high emission of light it is desirable to apply a drive signal between 4-12 kV.

The field emission light source disclosed in WO 2005074006 provides a promising approach to more environmentally friendly lighting, e.g. as no use of mercury is necessary. However it is always desirable to improve driving conditions for increasing life time and/or for reducing energy consumption.

### SUMMARY OF THE INVENTION

According to an aspect of the invention, the above is at least partly met by a field emission lighting arrangement, comprising a field emission light source comprising an anode and a cathode and having an inherent predetermined capacitance, an inductor having a predetermined inductance and connected to at least one of the anode and the cathode of the field emission light source, and a power supply connected to the field emission light source and the inductor and configured to provide a drive signal for powering the field emission light source, the drive signal comprising a first frequency component having a first frequency selected to be within a frequency range, based on the predetermined capacitance and the predetermined inductance, corresponding to the half power width at resonance of the field emission lighting arrangement.

The invention is based on the understanding that once the choices of the cathode and anode materials are made, the configuration and the physical dimensions of the lamp are determined; the physical properties of the lamp may be determined. From the electric circuit point of view, some of these properties may be identified with those of electronic components, like a diode, capacitor and inductor with predetermined resistance, capacitance and inductance. The lamp as a whole therefore manifests like these components in different ways, most importantly a resonance circuit under different driving conditions, such as DC, driving, low frequency driving and resonance frequency driving. Any frequency below the resonance frequency is defined as low frequency. By adjusting the capacitance and/or inductance inside and/or outside the lamp, it is possible to choose a desired resonance frequency and a phase relation between the input voltage and the current.

In accordance with the invention, the selection of the first frequency to be such that the half power width at resonance of the field emission lighting arrangement is achieved is understood to mean that the first frequency is selected to be centered around the resonance frequency of the field emission lighting arrangement and being within a frequency range such that half of the total power is contained. Put differently, the first frequency is selected to be somewhere within the range of frequencies where drive signal has a power above a certain half the maximum value for its amplitude.

Advantages with the inclusion of an inductor together with the selection of a drive signal for arranging the field emission lighting arrangement at resonance includes lower power consumption of the field emission lighting arrangement as well as an increase in light output of the field emission lighting arrangement. More precisely, the field emission lighting arrangement preferably comprises a phosphor layer arranged adjacently with the anode. During operation, the cathode may emit electrons, which are accelerated toward the phosphor layer. The phosphor layer may provide luminescence when the emitted electrons collide with phosphor particles. Light provided from the phosphor layer transmits through the anode, which is configured to be transparent (for example by using an indium tin oxide, “ITO”, based anode).

In a preferred embodiment, the first frequency is above 20 kHz, depending mostly on the inherent capacitance of the anode and the cathode. The drive signal may also comprise a second frequency component having a second frequency, the second frequency being lower than the first frequency, for example below 1 kHz. Advantageously, the second frequency component is arranged as a carrier for the first frequency component.

Preferably, the first and/or the second frequency components may be selected to have an essentially sinusoidal shape. However, other shapes are possible and within the scope of the invention.

For achieving a high lighting output, the second frequency component is arranged to have an amplitude above 10 kV. It is however possible to allow for the dimming of the light being emitted by the field emission lighting arrangement. In a dimming mode the amplitude may be within the range of 4-15 kV.

The inductor may be arranged either in series of in parallel with the anode and the cathode. The selection of the first frequency also depends on where the inductor is arranged.

In a preferred embodiment, the field emission lighting arrangement further comprises an evacuated chamber comprising the anode and the cathode and a base structure connected to the evacuated chamber and comprising the inductor and the power supply. By providing such an implementation, the field emission arrangement may be provided as a retrofitting device for the common light bulb. Accordingly, the base may be equipped with a screw of bayonet sleeve for fitting in an appropriate socket.

Further features of, and advantages with, the present invention will become apparent when studying the appended claims and the following description. The skilled addressee realize that different features of the present invention may be combined to create embodiments other than those described in the following, without departing from the scope of the present invention.

### BRIEF DESCRIPTION OF THE DRAWINGS

The various aspects of the invention, including its particular features and advantages, will be readily understood from the following detailed description and the accompanying drawings, in which:

FIGS. 1a-1c conceptually illustrate three different field emission lighting arrangements according to currently preferred embodiments of the invention;

FIG. 2 shows a diagram illustrating the concept of the half power width at resonance of the field emission lighting arrangement; and

FIG. 3 discloses a standalone field emission lighting arrangement according to another preferred embodiment of the invention.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled addressee. Like reference characters refer to like elements throughout.

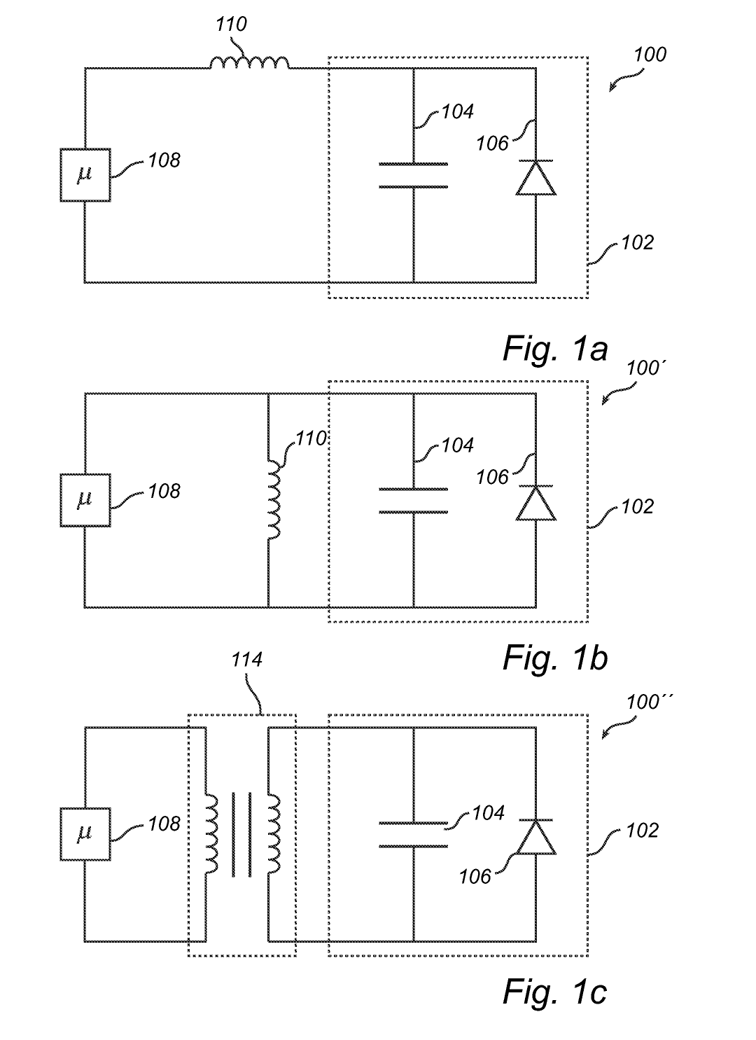

Referring now to the drawings and to FIG. 1a in particular, there is depicted a field emission lighting arrangement 100 according to a first currently preferred embodiment of the invention. The field emission lighting arrangement 100 comprises a field emission light source 102. The field emission light source 102 in turn comprises an anode and a cathode (not shown in FIG. 1a) and having an inherent capacitance 104. The field emission light source furthermore functions as a diode 106 and thus the electrical scheme of FIG. 1 illustrates the light source 102 as comprising such a component. The physical configuration of the field emission light source is for example disclosed in WO 2005074006, of the applicant and which is incorporated entirely by reference.

For driving the field emission light source 102, the field emission lighting arrangement 100 further comprises a control unit 108 which is arranged to provide a drive signal for controlling the field emission light source 102. The control unit 108 may include a microprocessor, microcontroller, programmable digital signal processor or another programmable device. The control unit 108 may also, or instead, include an application specific integrated circuit, a programmable gate array or programmable array logic, a programmable logic device, or a digital signal processor. Where the control unit 108 includes a programmable device such as the microprocessor, microcontroller or programmable digital signal processor mentioned above, the processor may further include computer executable code that controls operation of the programmable device.

The control unit 108 is preferably adapted to provide a high frequency (above 20 kHz) and high voltage (between 4-10 kV) dive signal, preferably having essentially sinusoidal features. Other waveforms are of course possible and within the scope of the invention. Additionally, the frequency of the signal is preferably adapted such that it corresponds to resonance frequency of the field emission light source 102, where the field emission light source 102 has been connected to an inductor 110 arranged in series with the field emission light source 102, for forming a resonance circuitry. Accordingly, the electrical circuit being formed by the field emission light source 102 and the inductor 110 is driven using the drive signal from the control unit 108 that is selected, together with the value/size of the inductor 110 such that the field emission lighting arrangement 100 is arranged at resonance. As discussed above, this improves lighting conditions of the field emission lighting arrangement 100, including for example improvements in relation to luminous efficacy (lm/W) of the field emission light source 102.

As is also discussed above, the selection of the frequency (Hz) and amplitude (V) of the control signal as well as the size of the inductor (H) 110 is based on the configuration and the physical dimensions of the field emission light source 102. That is, by adjusting the inductance, it is possible to choose a desired resonance frequency and a phase relation between the input voltage and the current provided by the control unit 108.

The electrical scheme of the field emission lighting arrangement 100 may take different forms; such as for example is illustrated in FIG. 1b. The field emission lighting arrangement 100′ as shown in FIG. 1b is slightly modified in comparison to the field emission lighting arrangement 100 as was shown in FIG. 1a. More precisely, in the embodiment illustrated in FIG. 1b, the inductor 110 has been replaced with another inductor 112, instead arranged in parallel with the field emission light source 102. This embodiment emphasizes that different electrical schemes are possible and within the scope of the invention.

The possibility to arrange the field emission arrangement 100 differently is further illustrated in FIG. 1c by the field emission arrangement 100″. In this embodiment, the inductor 110/112 has again been replaced, and instead there is provided a transformer 114 in between the field emission light source 102 and the control unit 108. The transformer 114 functions to increase the voltage amplitude of the drive signal provided by the control unit 108, and also provide the inductive component for creation of the resonance circuitry comprising the field emission light source 102 and the inductor as discussed above. That is, according to the invention, it is also possible to use the inherent inductive capacity of the transformer 114 for providing the inductive element to the field emission lighting arrangement 102″.

Turning now to FIG. 2 which illustrates the concept of the half power width at resonance of the field emission lighting arrangement, i.e. within which range the frequency of the drive signal may be selected to achieve resonance. That is, the frequency range, or selectable bandwidth, of the drive signal is determined as a measure of the width of the frequency response at the two half-power frequencies. As a result, this measure of bandwidth is sometimes called the full-width at half-power or half power width at resonance. More specifically, the electrical power is proportional to the square of the circuit voltage (or current), and thus the frequency response will drop to 1/\sqrt{2} at the half-power frequencies. In FIG. 2 the frequency response, of the field emission light source 102/102′/102″ together with the inductive component 110/112/114, respectively, is defined by the graph 200 having a peak value at resonance 202. The lower level for the frequency range is indicated by line 204 and the higher level is indicated by line 206. Additionally, the level at which the lower 204 and higher 206 lines crosses the graph of the frequency response 200 is where the frequency response is at 1/\sqrt{2} of the resonance peak 202.

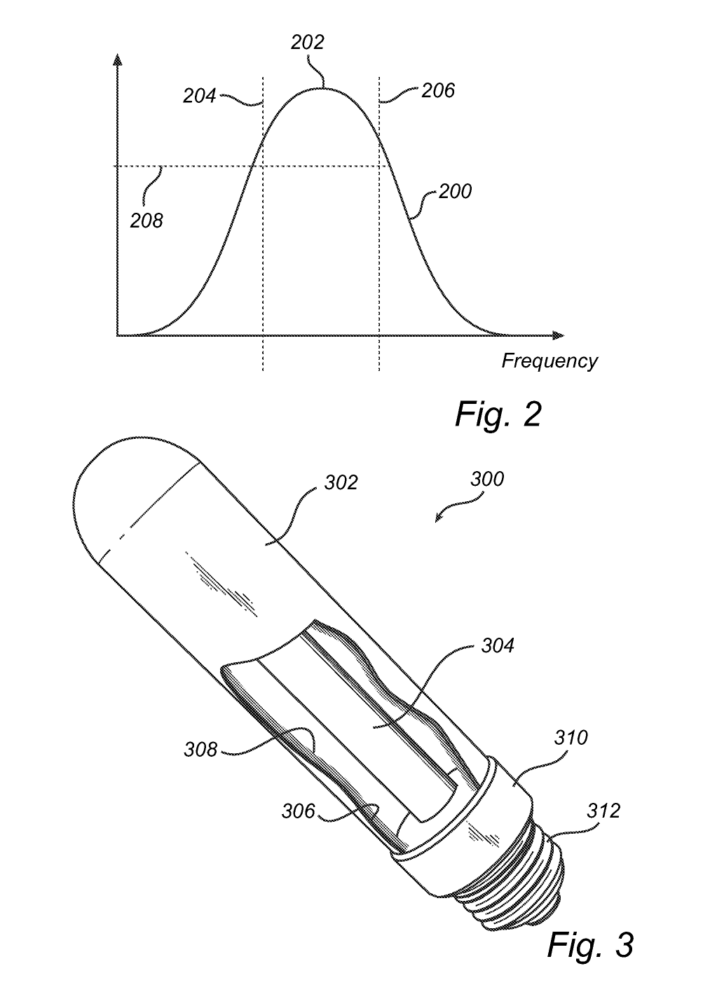

In FIG. 3 it is shown a conceptual illustration of a standalone field emission lighting arrangement 300 according to yet another preferred embodiment of the invention. The lighting arrangement 300 has the electrical characteristics as discussed in relation to any one of FIGS. 1a-1c, and is controlled using a drive signal selected to be in within the frequency range as discussed on relation to FIG. 2 and having a waveform and amplitude as discussed above. The field emission lighting arrangement 300 comprises an evacuated cylindrical glass tube 302 inside of which there arranged a cathode 304, for example made of a porous carbon material as disclosed in WO 2005074006. The glass tube 302 also comprises an anode consists of an electrically conductive layer 306 and a layer 308 of phosphors coated on the inner surface of the conductive layer 306 facing the cathode 304. The structure of the anode may for example correspond to the anode structure disclosed in WO05074006, of the applicant and which is incorporated entirely by reference.

The field emission lighting arrangement 300 further comprises a base 310 and a socket 312, allowing for the field emission lighting arrangement 300 to be used for retrofitting conventional light bulbs. The base 310 preferably comprises the control unit 108 and the inductive component 110/112/114 based on the specific implementation in hand.

Even though the invention has been described with reference to specific exemplifying embodiments thereof, many different alterations, modifications and the like will become apparent for those skilled in the art. Variations to the disclosed embodiments can be understood and effected by the skilled addressee in practicing the claimed invention, from a study of the drawings, the disclosure, and the appended claims. For example, even though the description above has been given in relation to a drive signal having a single frequency, it is of course possible and within the scope of the invention to allow for further frequencies with the drive signal. As an example, the frequency as discussed above (i.e. first frequency) may be provided “on top” of a carrier frequency (i.e. second frequency), depending on e.g. the solution to different implementation issues. The carrier need not have as high frequency as the first frequency, but may essentially correspond to the mains frequency at the place where the field emission lighting arrangement 300 is used.

Furthermore, in the claims, the word “comprising” does not exclude other elements or steps, and the indefinite article “a” or “an” does not exclude a plurality.

1. A field emission lighting arrangement, comprising:
a field emission light source comprising an anode and a cathode and having an inherent predetermined capacitance;
an inductor having a predetermined inductance and connected to at least one of the anode and the cathode of the field emission light source, and
a power supply connected to the field emission light source and the inductor and configured to provide a drive signal for powering the field emission light source, the drive signal comprising a first frequency component having a first frequency selected to be within a frequency range, based on the predetermined capacitance and the predetermined inductance, corresponding to the half power width at resonance of the field emission lighting arrangement.

2. Field emission lighting arrangement according to claim 1, wherein the first frequency is above 20 kHz.

3. Field emission lighting arrangement according to claim 1, wherein the drive signal further comprises a second frequency component having a second frequency, the second frequency being lower than the first frequency.

4. Field emission lighting arrangement according to claim 3, wherein the second frequency component is a carrier for the first frequency component.

5. Field emission lighting arrangement according to claim 3, wherein the second frequency is below 1 kHz.

6. Field emission lighting arrangement according to claim 1, wherein the first frequency component is essentially sinusoidal.

7. Field emission lighting arrangement according to claim 3, wherein the second frequency component is essentially sinusoidal.

8. Field emission lighting arrangement according to claim 3, wherein the second frequency component has an amplitude above 10 kV.

9. Field emission lighting arrangement according to claim 1, wherein the inductor is arranged in parallel with the anode and the cathode.

10. Field emission lighting arrangement according to claim 1, wherein the inductor is arranged in series with one of the anode and the cathode.

11. Field emission lighting arrangement according to claim 1, further comprising:
an evacuated chamber comprising the anode and the cathode; and
a base structure connected to the evacuated chamber and comprising the inductor and the power supply.
